(19) United States
(12) Patent Application Publication
(10) Pub. No.: US 2021/0318022 A1
(43) Pub. Date: Oct. 14, 2021

(54) VIEWING WINDOW FOR VENTILATION AND AIR-CONDITIONING SYSTEMS AND CLIMATE CHAMBERS

(71) Applicant: EMKA Beschlagteile GmbH & Co. KG, Velbert (DE)

(72) Inventor: Thorsten KUHNKE, Mettmann (DE)

(21) Appl. No.: 17/285,625

(22) PCT Filed: Oct. 10, 2019
(86) PCT No.: PCT/DE2019/100879

§ 371 Date: Apr. 15, 2021

(30) Foreign Application Priority Data
Oct. 15, 2018 (DE) 10 2018 125 499.7

(51) Int. Cl. F24F 13/20; E06B 3/58; E06B 7/30

(52) U.S. Cl. CPC F24F 13/20; E06B 7/30; E06B 3/5892

(57) ABSTRACT

A viewing window for insertion into a viewing opening in a ventilation and air-conditioning system and/or a climate chamber, the viewing window including two pane supports which can be connected to one another by a rotary joint that is prevented by a notched locking mechanism from accidentally coming loose.

### TECHNICAL FIELD

The present invention relates to a viewing window for insertion into a viewing opening, in particular a viewing opening of HVAC systems and/or a climate chamber, having two pane supports which are connectable to one another by way of a rotary connection.

### BACKGROUND

Heating, ventilating and air-conditioning systems (HVAC systems) as well as climate chambers are equipped with various types of machines, systems, system components, apparatuses, etc., for various applications above all in the industrial sector. Such HVAC systems or climate chambers in most instances have closed system housings in which different operating or climatic conditions which to some extent can significantly differ from the ambient conditions outside the system housing may prevail. Conditions with positive pressure as well as negative pressure, different temperature and/or air-humidity conditions, etc., can thus prevail in the interior of these system housings, which is why the walls of the system housings are typically configured so as to be pressure-tight and thermally insulating. The system housings typically used are made from an inner and an outer sheet-metal panel with a sandwich-like filler material in between, said filler material possessing sound proofing, insulating and other properties that are adapted to the respective application.

In order to be able to externally monitor a machine which is disposed in such a HVAC system from outside the system housing, for example, viewing openings having viewing windows inserted therein are provided at specific locations of the system housing, said viewing windows often being configured in the manner of portholes and potentially being situated in a side wall or a door of the system housing.

Such a viewing window is known from DE 10 2017 105 267 A1. In said viewing window, the pane composed of a transparent material is disposed on pane supports which can be inserted into the viewing opening and assembled therein from opposite directions. The assembling of the two pane supports in the viewing opening takes place by way of a rotary connection in that the two pane supports are rotated relative to one another and assembled in the manner of a screw connection in the viewing opening. In order to safeguard this rotary connection against being unintentionally released, one of the two pane supports upon assembly is screwed to the wall of the system housing. Any unintentional release of the pane support, for example in the case of comparatively strong vibrations or similar influences, is reliably prevented even over comparatively long periods.

It has however proven disadvantageous that a bore in the housing wall has to be provided for this type of reverse-rotating safeguard, which can have a number of this potentially being provided with several disadvantages. For example, if the rotary connection has to be retightened by virtue of a seal that yields over time, or a necessary replacement of a seal, or similar reasons, the hole originally drilled often cannot be used again as a reverse-rotation safeguard. In this case, a further bore has to be incorporated, so that a plurality of holes have to be drilled into the wall of the HVAC systems in unfavorable cases. Apart from the visual impact associated therewith, this is associated with a certain complexity in terms of assembling and the risk of contamination, humidity and similar influences entering the wall, and thus with a certain susceptibility to disruptions.

### SUMMARY

Proceeding therefrom, it is the object of the present invention to specify a viewing window which is distinguished by a more assembly-friendly and less disruption-prone reverse-rotation safeguard.

In a viewing window of the type mentioned as the outset, this object is achieved in that the rotary connection is secured by way of a latching mechanism against unintentionally being released.

By using a latching mechanism it is not necessary for any additional bores or similar elements to be incorporated in the housing wall. Any unintentional release of the rotary connection can be precluded in an assembly friendly as well as inconspicuous manner on account of the two pane supports latching to one another.

One advantageous design embodiment of the invention provides that the latching mechanism is functionally coupled to the rotary connection. On account of the rotary connection being functionally coupled to the latching mechanism, by activating the rotary connection, the latching mechanism is activated and the rotary connection is simultaneously automatically locked in the respective rotary position thereof. No additional operating steps are therefore required in order for the latching mechanism to be activated.

The latching mechanism is advantageously configured in the manner of a ratchet. Securing the rotary connection can take place at discrete spacings and thus rotary angles on account of the latching mechanism being designed in the manner of a ratchet.

A embodiment which is advantageous in terms of construction provides that the latching mechanism has at least one latching element which is disposed on the one pane support, and a plurality of latching elements which are disposed on the other pane support. The latching element which is disposed on the one pane support can latch to a plurality of latching elements of the other pane support at various latching positions and in this way secure the rotary connection against being unintentionally released at various positions. One particularly advantageous design embodiment provides that two latching mechanisms are disposed on the one pane support on opposite circumferential regions of the one pane support, a multiplicity of the second latching elements on the other pane support being assigned to said two latching mechanisms.

In this context, it is furthermore advantageous for the latching elements disposed on the other pane support to have a predefined latching spacing. The rotary safeguarding action can take place at larger or smaller angular spacings, in a manner corresponding to the latching spacing.

One advantageous embodiment in terms of construction provides that the plurality of latching elements have an undulating, jagged and/or scale-shaped contour. An undulating contour permits the pane supports to be rotated in the connecting direction as well as the releasing direction of said pane supports using a substantially identical effort in terms of force. The same may apply to a jagged contour. In the case of a scale-shaped contour of the latching elements, the scale shape can be chosen such that a higher resistance results so as to counter an unintentional release than when connecting the two pane supports to one another. In the case of a barb-shaped contour, the barbed geometry of the latching elements can be chosen such that the two pane supports upon assembly cannot be separated from one another in a destruction-free manner.

One particularly advantageous embodiment provides that the latching elements have a predefined latching spacing. The angular indexing of the latching mechanism can be set by way of the latching spacing. A finer angular indexing, and thus the possibility of a finer latching mechanism, results in the case of a smaller spacing.

It is moreover proposed that the plurality of latching elements form a latching section. The latching elements can be successively disposed in the manner of a string of pearls. The other latching element can be moved along the latching section and latch at various latching positions in the latching section.

One further embodiment of the invention provides that the one pane support for establishing the rotary connection has at least one tab-shaped fastening element which for forming the rotary connection is able to be brought to engage with at least one fastening means of the other pane support that is helically configured at least in portions. By rotating the two fastening means in relation to one another, the rotating movement in a manner corresponding to the pitch of the helically configured fastening means is converted to a translatory movement, and the two pane supports, converging from the axial direction, are mounted in the viewing opening.

In this context it is furthermore advantageous for the plurality of latching elements to be assigned to the fastening means that is helically configured at least in portions. In this way, a coupling between the rotary connection and the reverse rotation safeguard can be implemented in a favorable manner.

In this context it is particularly advantageous for the latching section to be disposed so as to be parallel to the at least one fastening means that is helically configured at least in portions. In this way, the rotary connection can be established and at the same time the latching mechanism achieved in a compact manner.

One latching section is advantageously assigned to each fastening means that is helically configured at least in portions. In the case of a plurality of helical fastening means the latter can be selectively used, and one separate latching section is in each case available for the latching mechanism independently of said selection.

One further embodiment in terms of construction provides that a latching element is disposed on the tab-shaped fastening means. The latching mechanism in the region of the rotary connection can be established by way of the fastening means.

According to one further design embodiment, the latching element can project in the manner of the latching cam from the engagement element, for example. The latching cam can engage in a form-fitting manner in the latching contours of the latching section at various latching positions.

A design embodiment according to which the latching element is configured so as to be able to latch in an intermediate region between two latching elements is advantageous. The latching action can take place in a form-fitting and/or force-fitting manner.

In terms of the latching element it is finally proposed that the latter is configured so as to be narrower and/or shorter than the fastening means. In this way, the latching element can be excluded from the force flux of the rotary connection and serve only for the latching mechanism.

### BRIEF DESCRIPTION OF THE DRAWINGS

Further details and advantages of the present invention will be explained hereunder with the aid of an exemplary embodiment illustrated in the figures in which:

FIG. 1 in a highly schematic illustration shows the view of a system housing of a HVAC system or a climate chamber having two viewing windows;

FIG. 2 shows an enlarged view of one of the two viewing windows;

FIGS. 3 and 4 show perspective views of the two pane supports of the viewing window from FIG. 2;

FIGS. 5 to 7 show various views of one of the two pane supports;

FIG. 8 shows a perspective view of the two pane supports in the assembled state;

FIG. 9 shows an illustration of the viewing window in a lateral view, corresponding to the illustration in FIG. 8;

FIGS. 10 and 1 show a perspective view of a viewing window for visualizing the procedures when fastening the viewing window in the viewing opening;

FIGS. 12 to 14 show perspective views for visualizing the adaptation of the wall thickness of the viewing window according to the invention; and

FIG. 15 shows an exploded view of the viewing window;

FIG. 16 shows a partially sectional perspective view of a viewing window;

FIG. 17 shows a sectional view of the viewing window from FIG. 16;

FIG. 18 shows a perspective view of a pane support;

FIG. 19 shows a perspective view of another pane support;

FIG. 20 shows the pane supports from FIG. 18 and FIG. 19 in the assembled state in a lateral view;

FIG. 21 shows the pane supports from FIG. 18 and FIG. 19 in the assembled state in a perspective view;

FIG. 22 shows a sectional view of an assembled viewing window;

FIG. 23 shows an enlarged detailed illustration according to the illustration in FIG. 22;

FIG. 24 shows a perspective view of an assembled viewing window;

FIG. 25 shows an exploded view of the viewing window from FIG. 24;

FIG. 26 shows an exploded view corresponding to that of FIG. 25 when viewed from another direction; and

FIG. 27 shows a frontal view onto parts of the viewing window.

### DETAILED DESCRIPTION

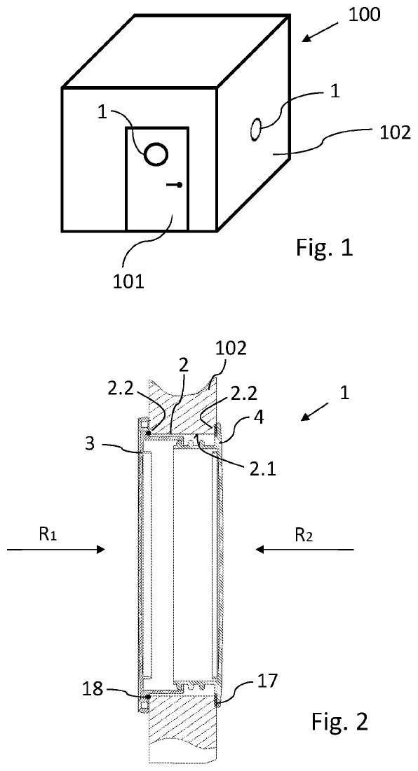

FIG. 1 in a highly schematic manner shows a view of a system housing 100. The system housing 100 can be the housing of a HVAC system or the housing of a climate chamber, such as are widely used for various applications in the industrial sector.

Various machines, systems, system components, apparatuses and similar can be disposed in the interior of the system housing 100 which in the exemplary embodiment according to FIG. 1 is accessible by way of a door 101. Operating conditions which in most instances differ in terms of pressure and temperature from the ambient conditions prevailing outside the system housing 100 prevail in the interior of the system housing 100. For this reason, in order for the devices disposed in the system housing 100 to be checked, it is not possible to simply open the door 101 and to inspect said devices. This is because the operating conditions within the system housing 100 would be compromised by opening the door 100, this being undesirable in many cases.

In order for a machine which is disposed within the system housing 100 to be able to be monitored from outside the system housing 100, for example, two viewing windows 1 which are in each case provided with panes and, in the manner of portholes, permit viewing of the systems and machines accommodated in the interior of the system housing 100 without the door 101 having to be opened to this end, are provided in the exemplary embodiment according to FIG. 1. The one viewing window 1 is disposed in the door 101; the other viewing window 1 is disposed in a housing wall 102. The viewing windows 1 are identically configured and assembled for assembling in the wall as well as in the door, which is why the explanations hereunder are focused on the assembly in the wall. It is understood that the viewing window 1 can also be assembled in the door 101 in an identical manner.

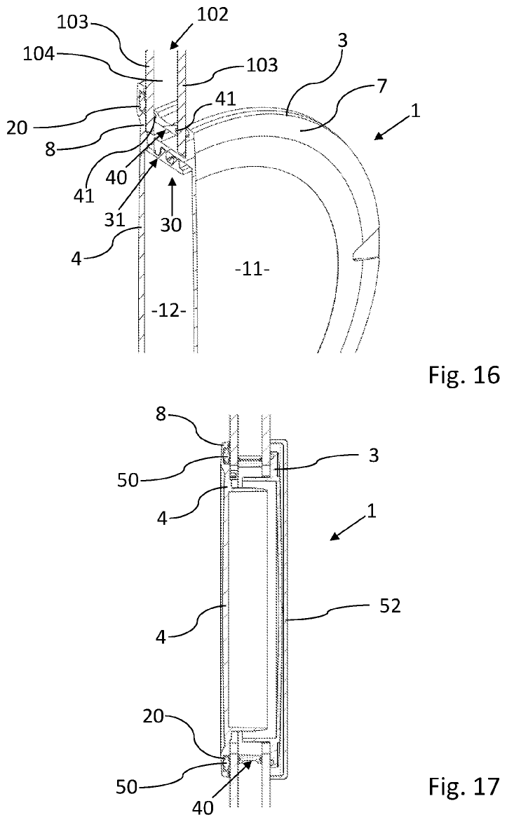

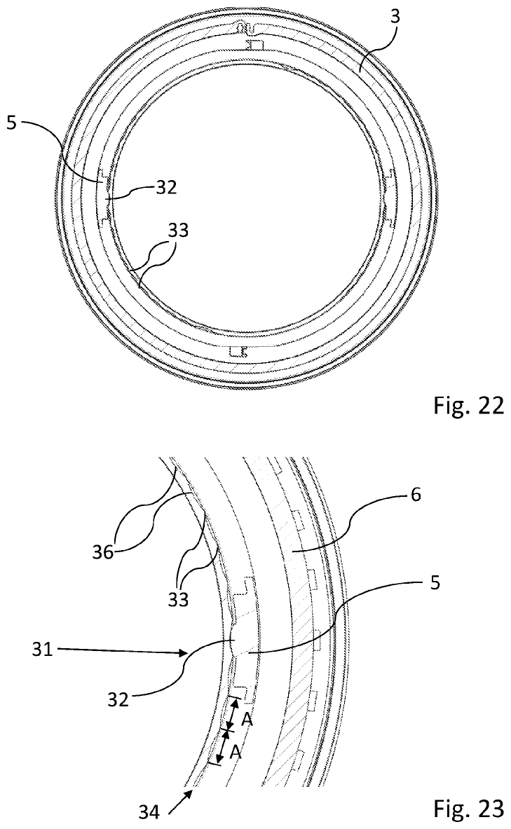

The construction and the assembly of the viewing windows 1 will first be explained in general terms hereunder by means of the illustrations in FIGS. 2 to 15, before details of the latching mechanism 31 of the viewing windows 1 will be discussed by means of the illustrations in FIGS. 16 to 21, and the details of an illumination element 50 of the viewing windows 1 will be discussed by means of FIGS. 22 to 27.

As can be seen in the illustration in FIG. 2, the viewing window 1 has a cylindrical geometry and is inserted into an approximately cylindrical viewing opening 2 within a housing wall 102 of the system housing 100.

As can be further seen in the illustration in FIG. 2, the viewing window 1 is assembled from two parts. The one part of the viewing window 1 is formed by a pane support 3 which along the direction R₁ is inserted into the view opening 2 from the one side of the housing wall 102. The second part of the viewing window 1 is formed from a further pane support 4 which along the direction R₂ is inserted into the viewing opening 2 from the opposite side of the housing wall 102.

The housing wall 102 of the system housing 100 can be, for example, a solid housing wall 102 or a sandwich-type housing wall 102 which is formed from metallic surfaces and an insulation material disposed therebetween and which is provided with a viewing opening 2 configured in the manner of a through-bore.

The viewing window 1 in an assembly friendly manner having few sealing points is inserted into the viewing opening 2 of the housing wall 102 so as to be gas-tight and not prone to leakage. To this end, sealing elements 17, 18 which are composed from a rubber-elastic material are provided on both sides of the housing wall 102 which in FIG. 2 is of a solid configuration. The sealing elements 17, 18 are braced between an encircling collar of the pane supports 3, 4 and the opposite edge 2.2 of the viewing opening 2. The one sealing element 18 has a round cross section and the other sealing element 17 has a rectangular cross section, wherein other cross sections would also be conceivable. Both sealing elements 17, 18 have an annular geometry and extend along the edge 2.2 of the viewing opening 2 around the latter.

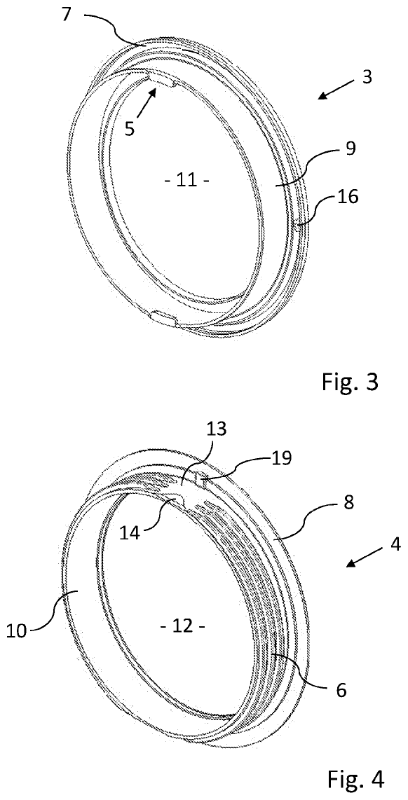

While the two pane supports 3, 4 are illustrated in the assembled state in FIG. 2, the two pane supports 3 and 4 are in each case shown separately in a perspective view in FIGS. 3 and 4.

The pane support 3 is configured in the manner of a cover and supports a windowpane 11 from an optically transparent material. The window frame 7 which surrounds the windowpane 11 is provided for fastening the windowpane 11 to the pane support 3. A fastening portion 9 which is smaller in terms of the diameter adjoins the window frame 7. The fastening portion 9 has a tubular geometry and in the exemplary embodiment is integrally connected to the window frame 7. In the exemplary embodiment, the windowpane 11 as well as the window frame 7 surrounding the former, as well as the fastening portion 9, are produced from an optically transparent material and in particular a plastics material. Alternatively, it would also be possible for the fastening portion 9 to be produced from a non-transparent material and for the latter to be connected to the window frame 7.

In this case, the pane support 3 would be made from two pieces. The advantage of the non-transparent region 9 would be that it would be impossible for an observer to look through the viewing window 1, beyond the inner casing face 2.1 of the viewing opening 2, obliquely into the interior of the housing wall 102, a mineral insulation material being situated there in the case of a sandwich-type housing wall 102, for example.

The pane support 3 at the free end of the fastening portion 9 has a fastening means 5 which is configured in such a manner that said fastening means 5 interacts with a corresponding fastening means 6 of the other pane support 4 as a result of the relative movement of the two fastening means 5, 6.

In the exemplary embodiment, the fastening means 5 is formed by two radially inward-projecting tabs. More tabs may also be used as fastening means 5. The use of tabs which have a more helical configuration would also be conceivable. The tabs can also be configured so as to be longer or shorter. It is important that said tabs are suitable for entering a helix of the other fastening means 6 and for fastening the pane supports 3, 4 in the viewing opening 2.

FIG. 4 shows the other pane support 4 in a perspective view. The pane support 4 has a windowpane 12 from a transparent material. The windowpane 12 is surrounded by a window frame 8 which is adjoined by a fastening portion 10. To this extent, the design embodiment of the pane support 4 is identical to that of the pane support 3. The pane support 4 can also be made from one piece in a transparent material, or the fastening region 10 can be embodied as a separate piece in a non-transparent material.

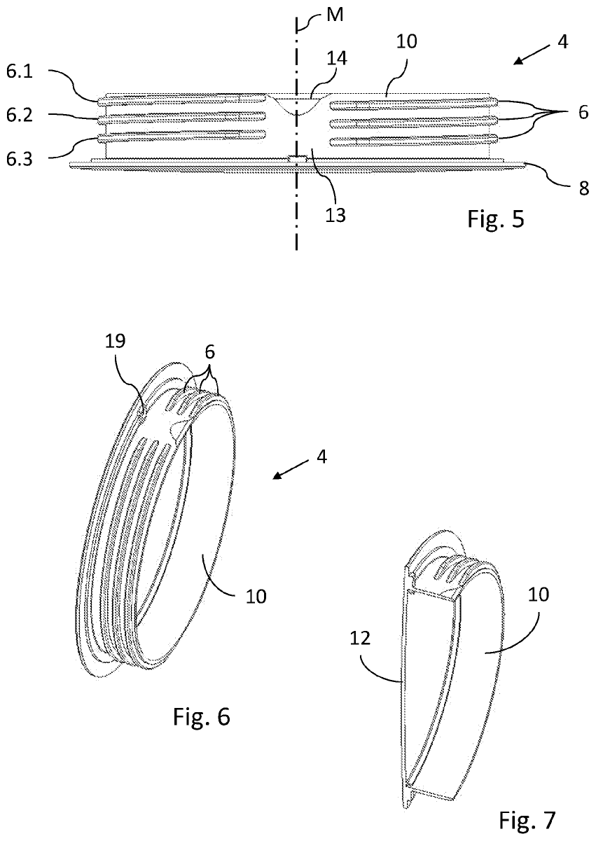

Details of the fastening means 6 of the pane support 4 are also illustrated in FIGS. 5 to 7.

The fastening means 6 in the pane support 4 are formed by helical or partially helical elements which are disposed on the circumference of the cylindrical fastening portion 10. In the exemplary embodiment, the fastening means 6 are formed by a total of three helix portions 6.1, 6.2 and 6.3 which are disposed so as to be mutually offset in the direction of the assembly axis M of the viewing window 1. In principle, a single such helix portion 6.1, 6.2 or 6.3 would be sufficient for assembling the viewing window 1. However, a possibility for rapidly adapting the viewing window 1 to different wall thicknesses of the housing wall 102 is achieved by a plurality of helix portions, this yet to be explained in more detail hereunder.

It can furthermore be seen that the helix portions 6.1, 6.2 and 6.3 are not configured so as to be continuous but on two opposite sides, so as to correspond to the number of fastening means 5 of the other pane support 3, are provided with an insertion opening 13 into which the fastening means 5 of the other pane support can be introduced. The insertion openings 13 have a duct-shaped cross section. The insertion openings 13 at the insertion side are provided with an introduction ramp 14 for facilitating the introduction.

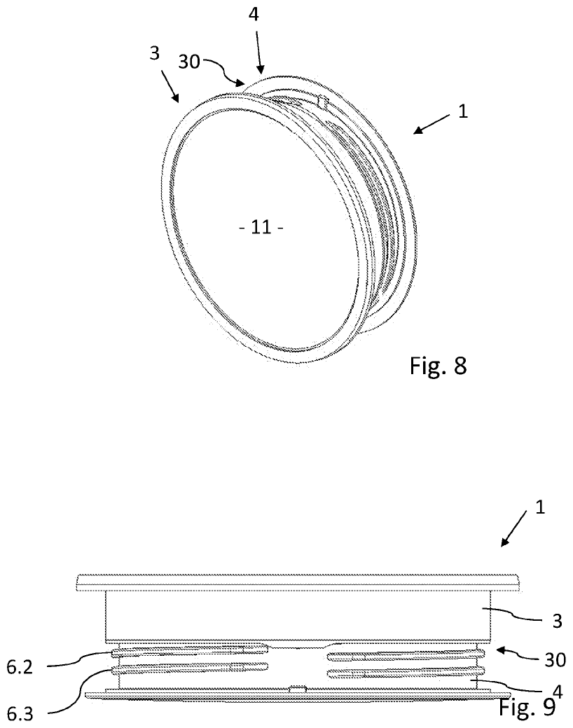

The procedures when assembling the two pane supports 3, 4 so as to form a common viewing window 1 are visualized in FIGS. 8 to 11.

The two pane supports 3, 4 within the viewing opening 2 are first converged from opposite directions R₁, R₂ along the assembly axis M. The tab-type fastening means 5 herein enter the region of the insertion opening 13 until the two pane supports 3, 4 by way of their window frames 7, 8 come to bear on the periphery of the viewing opening 2 and any further axial movement is no longer possible. To this extent, the window frames 7, 8 form detents.

In this position, an anti-rotation safeguard 19 which is disposed on the one pane support 4 interacts with a mating contour on the housing wall 102 in such a manner that the pane support 4 can no longer be rotated within the viewing opening 2. The anti-rotation safeguard 19 in the exemplary embodiment is formed by a form-fit element which is disposed on the window frame 8 of the pane support 4 and interacts in a form-fitting manner with a mating structure on the housing wall 102. In the exemplary embodiment, the anti-rotation safeguard 19 is formed by a protrusion, and the mating structure on the housing wall 102 is formed by a recess. Alternatively however, it would also be possible for the anti-rotation safeguard 19 to be formed by a recess, and for the mating structure on the housing wall 102 to be formed by a protrusion.

The one pane support 3 is then moved relative to the other pane support 4, and the fastening means 5, 6 are activated on account thereof, that is to say that the fastening means 5, 6 are brought to mutually engage. The relative movement is a relative rotation of the two pane supports 3, 4 as a result of which the latter are connected to one another in a screw-like manner by way of a rotary connection 30. And entrained rotation of the pane support 4 in the viewing opening 2 is precluded by way of the anti-rotation safeguard 19.

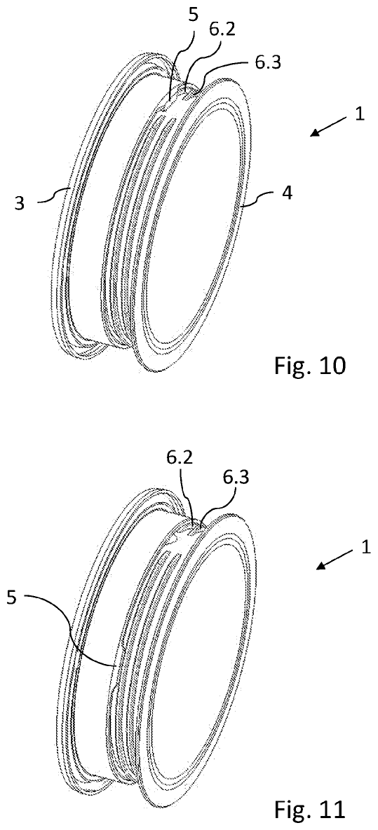

In the establishment of the rotary connection 30 of the two pane supports 3, 4, the tab-type fastening means 5 first enter the region of the helical portions 6.1, 6.2, 6.3 (cf. also the illustrations in FIGS. 10 and 11). Depending on the thickness of the housing wall 102, said fastening means 5 selectively come to bear behind one of the helix portions 6.1, 6.2 or 6.3. In the further rotation, the corresponding helix portion 6.1, 6.2 or 6.3 by virtue of the pitch thereof exerts an axial force on the fastening means 5. Consequently, the two pane supports 3, 4, while compensating any potential production tolerances, move in each case in the axial direction toward the housing wall 102 until the sealing elements 17, 18 have been sufficiently compressed and the viewing window sits in a pressure-tight manner in the viewing opening 2.

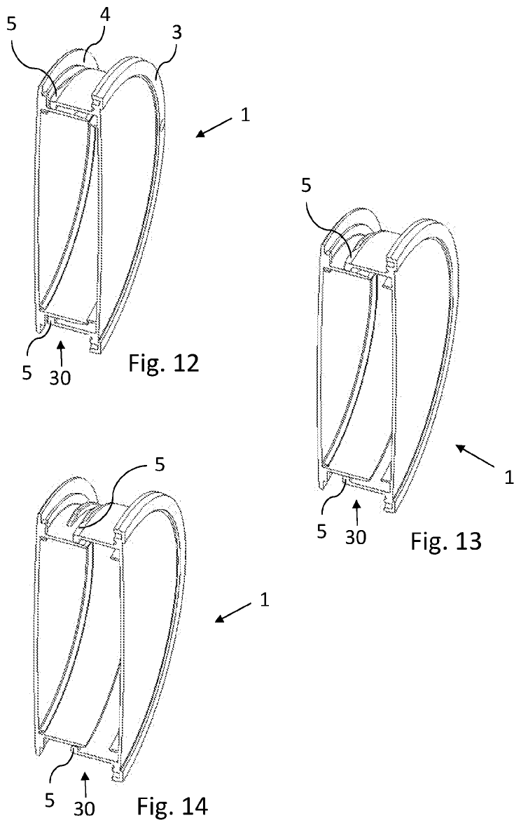

Three helix portions 6.1, 6.2, 6.3 which serve as wall thickness compensators for different wall thicknesses of the housing wall 102 of the system housing 100 in the region of the viewing opening 2 are provided in the exemplary embodiment, so that one and the same viewing window 1 can be used for different wall thicknesses. This will be explained hereunder by means of the illustrations in FIGS. 12 to 14.

Illustrated in FIG. 12 is a view of the assembled viewing window 1 in a viewing opening 2 of a comparatively thin housing wall 102. In the latter, the fastening means 5 of the pane support 3 are brought to bear and locked by rotation behind that helix portion 6.3 of the other pane support 4 that is closest to the window frame 7 of the pane support 4. FIG. 13 shows an installed situation in a viewing opening 2 of a housing wall 102 of an average thickness, in which the fastening means 5 come to bear behind the central helix portion 6.2. FIG. 14 finally shows an installed situation in which the fastening means 5 bear on that helix portion 6.3 that is disposed on the front end of the fastening portion 10. In this way, the viewing window 1 can be selectively used in housing walls 102 that are configured in different thicknesses by using the different helix portions 6.1, 6.2, 6.3. To this end it is not necessary for any modifications in terms of construction to be performed on the viewing window 1.

It is also not necessary for the two pane supports 3, 4 to first be mutually rotated multiple times about their own axis and run through a comparatively long helix in order to accommodate housing walls 102 of different thicknesses. Rather, the fastening means 5 can be introduced into the introduction opening 13 until the window frames 7, 8 of the two pane supports 3, 4 bear on the housing wall 102. A rotary connection 30 of the two pane supports 3, 4 can then be established by a rotating movement.

In this rotary connection 30, the pane support 3 that has the helical fastening means forms a type of screw, and the pane support 4 that has the tab-type fastening means 5 forms a type of nut.

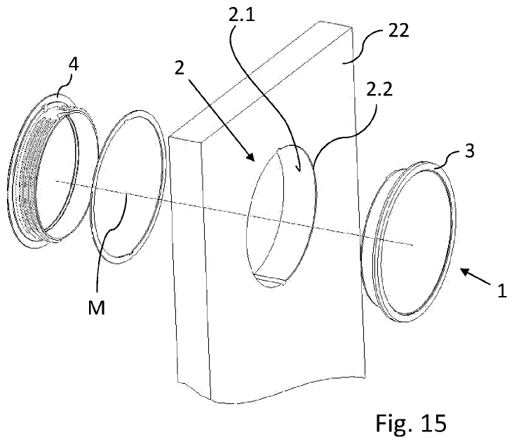

FIG. 15 once again shows the procedures when assembling the viewing pane 1 in an exploded illustration, the two pane supports 3, 4 thereof in the manner of a double-glazed porthole being inserted from two opposite directions into a housing wall 102. The two pane supports 3, 4 can be conjointly inserted in a simple and assembly friendly manner into the viewing opening 2 of a system housing 100 and be fastened so as to be air-tight therein by a rotary connection 30 without additional fastening elements such as, in particular threaded bolts or similar elements.

Since the details of the latching mechanism 31 as well as of the illumination element 50 are not illustrated in FIGS. 1 to 15 for reasons of clarity, said details will be explained in detail hereunder by means of the illustrations in FIGS. 16 to 27.

In the embodiment according to FIGS. 16 to 27, one difference in comparison to the viewing window 1 described above lies in that the viewing window 1 is not inserted into a solid housing wall 102 of a system housing 100 but into a housing wall 102 which is constructed in the sandwich-construction mode (cf. FIGS. 15 and 16).

The housing wall 102 in this embodiment has a multilayer construction having two board-shaped elements 103 which can in particular be sheet-metal panels. An intermediate space 104 for receiving a filler material is provided between the elements 103. The filler material can be, for example, a mineral insulation wool, or a similar filler material. The viewing window 1 in principle corresponds to the features described above, and by virtue of the sandwich-construction mode of the housing wall 102, differs only in that an intermediate ring 40 is disposed in the region between the board-shaped elements 103, said intermediate ring 40 not being required in the case of a solid housing wall 102.

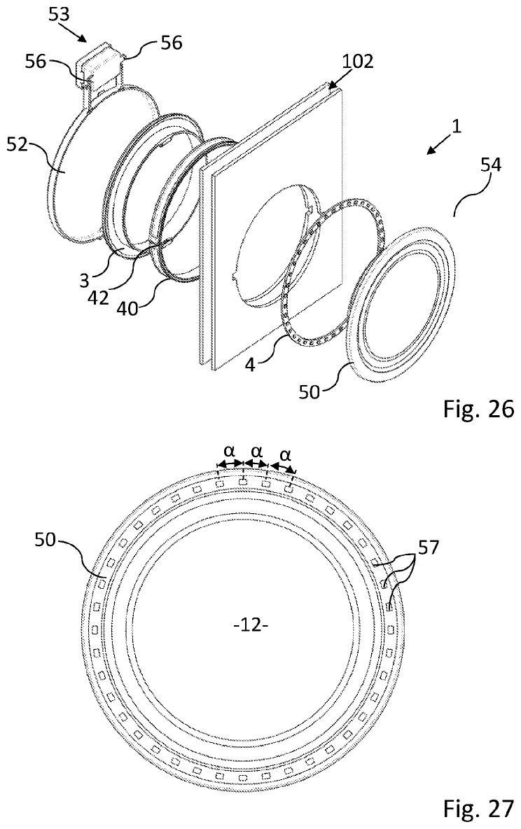

The intermediate ring 40 according to the illustrations in FIGS. 16 and 17 is disposed in the region of the viewing opening 2 so as to be between the board-shaped elements 103, and surrounds the viewing opening 2 in a position which is concentrically offset toward the outside. In order to be able to be inserted into the position illustrated between the two elements 103 also as a retrofit solution, the intermediate ring 40 has a separation point 42 (cf. also FIG. 26). By temporarily releasing the separation point 42, the intermediate ring 40 for purposes of assembly can be deformed in such a manner that said intermediate ring 40 can be incorporated and correspondingly disposed by way of the viewing opening 2 which in the region between the window frames 7, 8 illustrated in FIGS. 16 and 17 is of a smaller radius.

In the case of the housing wall 102 which is of a sandwich-like construction, the intermediate ring 40 fulfils a plurality of functions at once.

The primary function of the intermediate ring 40 first lies in achieving a pressure-tight support of the two board-shaped elements 103. The board-shaped elements 103 are formed by thin-walled sheet-metal plates which are thus easily deformable. The intermediate ring 40 therefore sits in the manner of a spacer between the window frames 7, 8 of the pane supports 3, 4. When the rotary connection 30 is tightened, the two thin-walled elements 103 are therefore not deformed toward the inside but pushed against the end sides of the intermediate ring 40 and supported thereon. Unintentional deformations of the elements 103 are thus precluded.

The intermediate ring 40 moreover also has a sealing function. To this end, the intermediate ring 40 at the end sides thereof possesses in each case one sealant receptacle 41. The sealant receptacle 41 in the manner of a groove extends along the end side of the intermediate ring 40. A seal which is composed of a rubber-elastic material can be received in the sealant receptacle 41 so as to seal the interior of the housing wall 102 in relation to the region of the viewing window 1 or the viewing window 2, respectively. The conditions in terms of the air and the climate that prevail in the interior of the housing wall 102 are therefore not transmitted to the interior of the viewing window 1. The risk of any unintentional fogging of the viewing window 1 is significantly reduced.

A third function of the intermediate ring 40 finally lies in that the latter is composed of an optically non-transparent material and to this extent forms a screen. It is therefore not possible for an observer to look into the region between the two board-shaped elements 103 and onto the filler material disposed therein by way of the windowpanes 11, 12. The fastening portions 9, 10 of the pane supports 3, 4 can therefore be configured so as to be transparent, advantageously having an opal-glass surface.

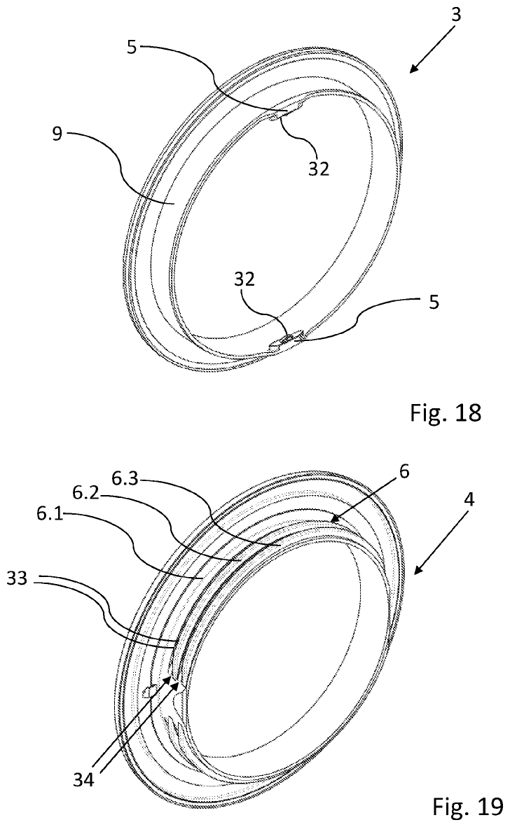

Details of the latching mechanism 31 will now be explained below by means of the illustrations in FIGS. 18 to 23.

FIG. 18 in a perspective view shows the pane support 3. One latching element 32 is in each case provided so as to project radially inward on the fastening means 5. The latching element 32 is configured in the manner of a latching cam and, when establishing the rotary connection 30, interacts in the latching manner with the latching elements 33 that are provided on the other pane support 4.

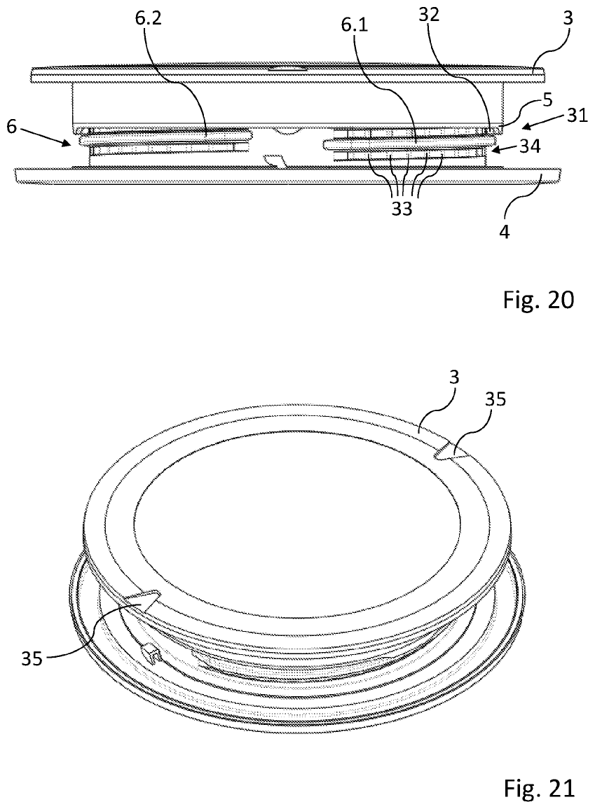

The latching elements 33 of the other pane support 4 can be seen in FIGS. 19 and 20. A multiplicity of latching elements 33 can be seen in the region of the fastening means 6 which is formed by a plurality of helix portions 6.1, 6.2, 6.3. The latching elements 33 are disposed so as to be parallel to the helix portions 6.1, 6.2, 6.3. Each of the helix portions 6.1, 6.2, 6.3 is assigned a latching section 34 which is formed by a plurality of lined-up latching elements 33 and to which the latching element 32 latches on account of the fastening means 5 engaging on the fastening means 6 when the rotary connection 30 is being established. When the pane supports 3, 4 are mutually rotated, the latching element 32, similar to a ratchet, is moved along one of the latching sections 34 and latches between two latching elements 33 as soon as the rotating movement ends. A latching mechanism 31 which prevents any unintentional reverse rotation, for instance by virtue of the vibrations acting on the viewing window 1, or seals which become porous over time, or similar circumstances, is formed on account thereof.

The rotary connection 30 is functionally coupled to the latching mechanism 31. The latching mechanism 31 is also automatically activated when the rotary connection 30 is being established. When the two pane supports 3, 4 are rotated in order for the rotary connection 30 to be established, it is therefore necessary for a certain force to be applied in order for the latching element 32 to be able to jump from one latching position between two latching elements 33 to the next latching position.

To this end, the fastening portion 9 of the pane support 3 temporarily widens and, by virtue of the inherent elasticity of the material, snaps back to its initial position. Corresponding force-introduction points 35 are provided on the pane support 3 in order for the necessary force to be applied. The force-introduction points 35 are configured in the manner of spanner flats. The force-introduction points 35 can be gripped using a special tool, and the pane support 3 can be rotated using a sufficiently high tightening torque.

The forces required for this also have to be overcome in the opposite direction when releasing the rotary connection 30, this not being the case under normal circumstances so that the rotary connection 30 is reliably secured against unintentional reverse rotation.

Further details of the latching mechanism 31 can be seen by means of the illustrations in FIGS. 22 and 23. As can be seen in particular in the illustration in FIG. 23, a latching section 34 which is formed from a multiplicity of latching elements 33 is disposed so as to be parallel to a fastening means 6, or the helix portions thereof, respectively. The latching elements 33 have an undulating contour having depressions 36 which are disposed between the latching elements 33 and in which the latching element 32 can come to bear. The latching elements 33, or the depressions 36, respectively, along the latching section 34 have in each case a latching spacing A on account of which uniform latching in the manner of a ratchet results. Alternatively, the latching elements 33 could also have a jagged, scale-shaped or barb-shaped structure. On account thereof, different forces when tightening and releasing the rotary connection 30 can be achieved.

As is suggested by the illustration in FIG. 23, the rotating movements of the two pane supports 3, 4 can also terminate at a position at which the latching element 32 lies on top of a latching element 33. In such a case, a reverse rotation of the pane support 3 by at most half a latching spacing A will take place until the latching element 32 has entered the closest depression 36 and is latched between two neighboring latching elements 33. The latching spacing A and the pitch of the helix portions 6.1, 6.2, 6.3 are sized such that the resulting axial movement of the pane supports 3, 4 is negligibly minor. It is in particular not to be anticipated that the seals present lose their effect.

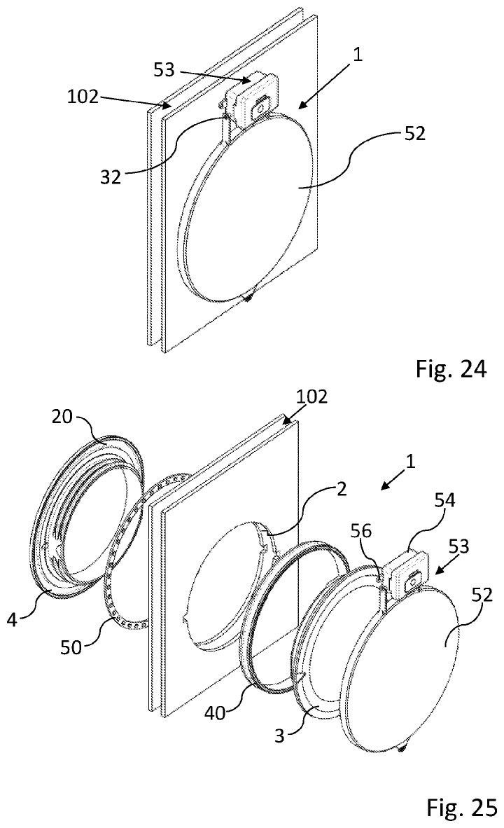

Details of the illumination element 50 will be explained hereunder by means of the illustrations in FIGS. 24 to 27.

FIG. 24 firsts shows the viewing window 1 in the viewing opening 2 of a housing wall 102 constructed in a sandwich-construction mode. The viewing window 1 on the external side thereof has a lid-type cover 52 which by way of a hinge joint 55 is articulated on a pivot bearing 53. The viewing window 1 by way of the cover 52 is closed in an opaque manner (cf. also the illustration in FIG. 17). The construction of the viewing window 1 is illustrated in a perspective view in FIG. 25 and corresponds substantially to the design embodiments described above.

The illumination element 50 is provided on the internal side of the viewing window 1. The illumination element 50, as has already become evident by means of the illustrations in FIGS. 16 and 17, is disposed in the region of the window frame 8 of the pane support 4. The window frame 8 has a receptacle groove 20 in which the illumination element 50 is accommodated. The window frame 8 is composed of an optically transparent material so that the illumination element 50 can illuminate the observation region in the interior.

A separate switch can be provided for activating the illumination element 50. In the exemplary embodiment it is provided that the cover 52 is operatively connected to the illumination element 50 in such a manner that the illumination element 50 is automatically switched on when the cover 52 is opened. The illumination element 50 is automatically switched off when the cover 52 is closed. It is prevented in this way that there is the possibility of the illumination element 50 continuing to be illuminated unobserved in the event of a closed cover 52, for instance on account of an operating error.

An electric power supply 54 which is configured in the manner of a battery box is provided for supplying electric power to the illumination element 50. The electric power supply 54 is integrated in the pivot bearing 53, on account of which a compact construction mode results. The battery box 54, or the pivot bearing 53, respectively, have two be fastened to the external side of the housing wall 102 by way of only two screw-connection points 56.

Details of the illumination element 50 can be seen in the illustrations in FIGS. 26 and 27.

The illumination element 50 is constructed as an annular LED having a multiplicity of illuminated dots 57 which are disposed so as to be uniformly distributed across the circumference of the illumination element 50. The illuminated dots 57 have in each case a mutual angular spacing α. On account of the illumination element 50 being disposed in the region of the window frame 7, the available region for looking through the viewing window 1 is not compromised. The illumination element 50, by virtue of the electric power supply 54 being integrated in the viewing window 1, can moreover be used independently of external electric power supply points at any suitable location.

### LIST OF REFERENCE SIGNS

1 Viewing window
2 Viewing opening
2.1 Internal face
2.2 Edge
3 Pane support
4 Pane support
5 Fastening means
6 Fastening means
6.1 Helix portions
6.2 Helix portions
6.3 Helix portions
7 Window frame
8 Window frame
9 Fastening portion
10 Fastening portion
11 Windowpane
12 Windowpane
13 Insertion opening
14 Introduction ramp
15 Reverse-rotation safeguard
16 Reverse-rotation safeguard
17 Seal
18 Seal
19 Anti-rotation safeguard
20 Receptacle groove
30 Rotary connection
31 Latching mechanism
32 Latching element
33 Latching element
34 Latching section
35 Force-introduction point
36 Depression
40 Intermediate ring
41 Sealant receptacle
42 Separation point
50 Illumination element
52 Cover
53 Pivot bearing
54 Electric power supply
55 Hinge joint
56 Screw-connection point
57 Illuminated dot
100 System housing
101 Door
102 Housing wall
103 Element
104 Intermediate space
R₁ Direction
R₂ Direction
M Assembly axis
A Latching spacing

1. A viewing window for insertion into a viewing opening, in particular a viewing opening of HVAC systems and/or a climate chamber, the viewing window comprising:
two pane supports which are connectable to one another by way of a rotary connection (30); and
wherein the rotary connection is secured by way of a latching mechanism against being unintentionally released.

2. The viewing window as claimed in claim 1, wherein the latching mechanism is functionally coupled to the rotary connection.

3. The viewing window as claimed in claim 1, wherein the latching mechanism is configured in the manner of a ratchet.

4. The viewing window as claimed in claim 1, wherein the latching mechanism has at least one latching element which is disposed on the one pane support, and a plurality of latching elements which are disposed on the other pane support.

5. The viewing window as claimed in claim 4, wherein the plurality of latching elements have an undulating, jagged, scale-shaped and/or barb-shaped contour.

6. The viewing window as claimed in claim 4, wherein the plurality of latching elements have a predefined latching spacing.

7. The viewing window as claimed in claim 4, wherein the plurality of latching elements form a latching section.

8. The viewing window as claimed in claim 1, wherein the one pane support for establishing the rotary connection has at least one tab-shaped fastening means which for forming the rotary connection is able to be brought to engage with at least one fastening means of the other pane support that is helically configured at least in portions.

9. The viewing window as claimed claim 4, wherein the plurality of latching elements are assigned to the fastening means.

10. The viewing window as claimed in claim 8, wherein the latching section is disposed so as to be parallel to the at least one fastening means that is helically configured at least in portions.

11. The viewing window as claimed in claim 8, wherein each of the at least one helically configured fastening means is assigned a latching section.

12. The viewing window as claimed in claim 4, wherein the latching element is disposed on the tab-shaped fastening means.

13. The viewing window as claimed in claim 4, wherein the latching element is configured as a latching cam.

14. The viewing window as claimed in claim 4, wherein the latching element is able to latch in an intermediate region between two latching elements.

15. The viewing window as claimed in claim 12, wherein the latching element is narrower and/or shorter than the fastening means.
